(19) United States
(12) Patent Application Publication
(10) Pub. No.: US 2013/0069015 A1
(43) Pub. Date: Mar. 21, 2013

(54) ELECTRODE FOR ELECTRIC-DISCHARGE SURFACE TREATMENT AND ELECTRIC-DISCHARGE SURFACE TREATMENT COATING

(71) Applicants: Nobuyuki Sumi, Tokyo (JP); Akihiro Goto, Tokyo (JP); Hiroyuki Teramoto, Tokyo (JP); Yoshikazu Nakano, Tokyo (JP)

(72) Inventors: Nobuyuki Sumi, Tokyo (JP); Akihiro Goto, Tokyo (JP); Hiroyuki Teramoto, Tokyo (JP); Yoshikazu Nakano, Tokyo (JP)

(73) Assignee: MITSUBISHI ELECTRIC CORPORATION, Tokyo (JP)

(21) Appl. No.: 13/699,794

(22) PCT Filed: May 26, 2010
(86) PCT No.: PCT/JP2010/003524

§ 371 Date: Nov. 26, 2012

(51) Int. Cl. H01B 1/04; C22C 38/02

(52) U.S. Cl. CPC H01B 1/04; C22C 38/02
USPC 252/512; 420/117; 420/8; 252/500; 252/520.22

(57) ABSTRACT

In order to establish an electric-discharge surface treatment capable of forming a smooth high-hardness coating, in the electric-discharge surface treatment in which pulsed electric discharge is generated between the electrode and a base material in a machining fluid or in the air by using a green compact, which is formed by compressing powder of an electrode material, as an electrode, and by using energy of the electric discharge, a coating including the electrode material or a reaction product of the electrode material reacted by the electric discharge energy is formed on a surface of the base material, wherein, as the powder of the electrode material, a mixed powder formed by mixing 10 to 75 vol % of Si powder to powder of a hard material is used.

### TECHNICAL FIELD

The present invention relates to electric-discharge surface treatment in which pulsed electric discharge is generated between an electrode and a base material by using a green compact, which is formed by compressing powder of a hard material, as an electrode, and by using energy of the electric discharge, a coating including an electrode material or a reaction product of the electrode material reacted by the electric discharge energy is formed on a surface of the base material.

### BACKGROUND ART

International Publication No. WO01/005545 discloses a practical electrode for electric-discharge surface treatment and a method of forming the same.

This technology is a method of forming a practical electrode for electric-discharge surface treatment which has a proper strength and safety and easily crumbles. In this method, TiC powder which is metal carbide powder and TiH₂ powder which is metal hydride powder are mixed, are compressed, and are heat-treated such that hydrogen is released from the TiFI₂ powder, whereby Ti powder is prepared.

JP-A-2005-21355 discloses a surface treating method for a dense and relatively thick coating (the order of 100 μm or greater) which needs a strength and lubricity in a high temperature environment.

This technology is a method of forming a dense and strong coating with high adhesion between powder materials by making an electrode contain 1.5 wt % (weight percent) to 5.0 wt % of Si or 1.0 wt % to 4.5 wt % of B such that Si or B absorbs oxygen atoms in the coating and thus the unnecessary oxygen atoms are removed from the coating.

As a result of an electric-discharge surface treatment experiment using an electrode for electric-discharge surface treatment as described above, the lives of press molds, turret punch presses, cutting tools, and the likes have extended.

Meanwhile, electric-discharge surface-treated surfaces have hardness of 1700 HV to 2500 HV, and are very hard. However, their roughness is slightly large as 6 μmRz to 12 μmRz. For this reason, for a purpose in which good surface roughness is necessary, it is required to form a smoother hard coating.

### CITATION LIST

### Patent Document

Patent Document 1: International Publication No. WO01/005545

Patent Document 2: JP-A-2005-21355

### DISCLOSURE OF THE INVENTION

### Problems that the Invention is to Solve

The present invention is made in view of the above-mentioned problem, and an object of the present invention is to provide an electric-discharge surface treatment method capable of forming a smooth high-hardness coating.

### Means for Solving the Problems

An electrode for electric-discharge surface treatment of the present invention is used in an electric-discharge surface treatment in which pulsed electric discharge is generated between the electrode and a base material in a machining fluid or in the air by using a green compact, which is formed by compressing powder of an electrode material, as the electrode, and by using energy of the electric discharge, a coating including the electrode material or a reaction product of the electrode material reacted by the electric discharge energy is formed on a surface of the base material, wherein, as the powder of the electrode material, a mixed powder formed by mixing 10 to 75 vol % of Si powder to powder of a hard material is used.

### Advantage of the Invention

According to the present invention, it is possible to form a smooth high-hardness coating.

### BRIEF DESCRIPTION OF DRAWINGS

FIG. 1 is a characteristic diagram illustrating a relation between a mixing ratio of Si in an electrode and a surface roughness of a coating.

FIG. 2 is a characteristic diagram illustrating a relation between the mixing ratio of Si in the electrode and a hardness of the coating.

FIG. 3 is a characteristic diagram illustrating a relation between the mixing ratio of Si in the electrode and a concentration of Si in the coating.

FIG. 4 is an SEM photo of a surface of a TiC coating which is a comparative example for a first embodiment.

FIG. 5 is an SEM photo of a surface of a Si-mixed TiC coating.

FIG. 6 is an SEM photo of a surface of another Si-mixed TiC coating.

FIG. 7 is an SEM photo of a surface of a further Si-mixed TiC coating.

FIG. 8 is an SEM photo of a surface of a Si coating which is a comparative example for a first embodiment.

FIG. 9 shows measured results of X-ray diffraction patterns from the surface directions of the Si-mixed TiC coatings.

FIG. 10 is a characteristic diagram illustrating a relation between the mixing ratio of Si in the electrode and a concentration of Ti in the coating.

FIG. 11 is a view illustrating a coating forming mechanism.

FIG. 12 is a characteristic diagram illustrating a relation between the mixing ratio of Si in the electrode and erosion resistance.

FIG. 13 shows observation results of surface states of coatings after injection of waterjet.

FIG. 14 is a characteristic diagram illustrating a relation between the mixing ratio of Si in the electrode and corrosion resistance.

FIG. 15 is observed results of the surface states of coatings after dipping in aqua regia for one hour.

FIG. 16 is a view illustrating a relation between the mixing ratio (weight ratio) of Si in the electrode and the characteristics of the coating.

FIG. 17 is a view illustrating a relation between the mixing ratio of Si in the electrode and concentrations of components of the coating.

### BEST MODE FOR CARRYING OUT THE INVENTION

Hereinafter, an embodiment of the present invention will be described with reference to the accompanying drawings.

### First Embodiment

The present embodiment will be described using TiC powder as powder of a hard material. Electrodes for electric-discharge surface treatment are made of mixed powders of TiC and Si prepared by mixing TiC powder and Si powder at slightly different ratios, and a voltage is applied between the electrode and a workpiece (base material) and electric discharge is generated, whereby a coating is formed on the base material. In the present embodiment, TiC powder having an average particle diameter of 5 μm or 1.3 μm and Si powder having an average particle diameter of 5 μm are used.

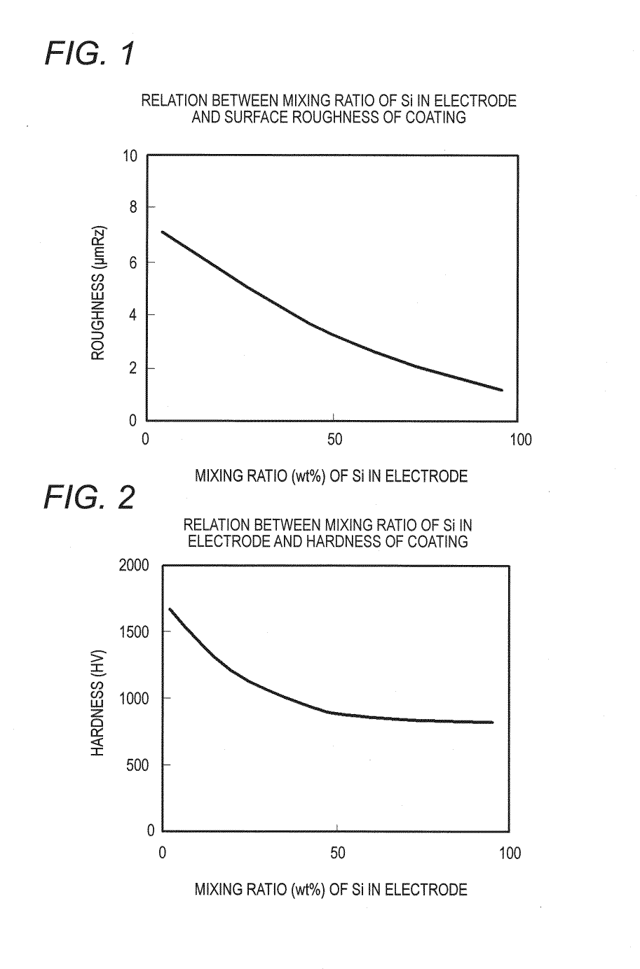

FIG. 1 is a view illustrating a relation between a mixing ratio (wt %) of Si in an electrode and a surface roughness of a coating.

As results of measurement of the surface roughness of coatings obtained by treating carbon steel S45C by the electrodes of TiC and Si formed while changing the mixing ratio of the Si powder to the TiC powder, as the mixing ratio of Si in the electrode increases, the surface roughness of the coating is reduced.

In the present embodiment, the surface roughness of the coating changes within a range of 2 μmRz to 6 μmRz.

FIG. 2 is a view illustrating a relation between the mixing ratio (wt %) of Si in the electrode and the hardness of the coating.

As the results of measurement of the hardness of coatings obtained by treating carbon steel S45C by the electrodes of TiC and Si formed while changing the mixed ratio of the Si powder to the TiC powder, when the mixing ratio of Si is 60 wt % or less, as the mixing ratio of Si in the electrode increases, the hardness of the coating is reduced.

Meanwhile, when the mixing ratio of Si is 60 wt % or greater, the hardness of the coating dies not change so much.

In the present embodiment, the hardness of the coating changes within a range of 800 HV to 1700 HV.

As shown in FIG. 1, since the surface roughness of the coating gradually reduces as the mixing ratio of Si in the electrode increases, it is possible to arbitrarily control the surface roughness of the coating between 2 μmRz to 6 μmRz by using an electrode obtained by arbitrarily changing the weight ratio of Si in the electrode.

Also, as shown in FIG. 2, since the hardness of the coating is gradually reduced as the mixing ratio of Si in the electrode increases, it is possible to arbitrarily control the hardness of the coating between 800 HV to 1700 HV by arbitrarily changing the weight percent of Si in the electrode.

Here, a method of measuring the surface roughness used in the present embodiment is as follows.

The measurement was made by using a Form Talysurf made by Taylor Hobson as a measuring apparatus, a standard stylus, a measurement length of 4.8 mm, a high-band cutoff length of 0.8 mm, a band width ratio of 100:1, and a Gaussian filter as a filter type. The measured values were based on JIS B0601:2001.

The measurement of the hardness of the coating was performed from the surface direction of the coating, and a measured load was 10 gf. A measuring apparatus is a micro hardness tester made by Shimadzu Corporation.

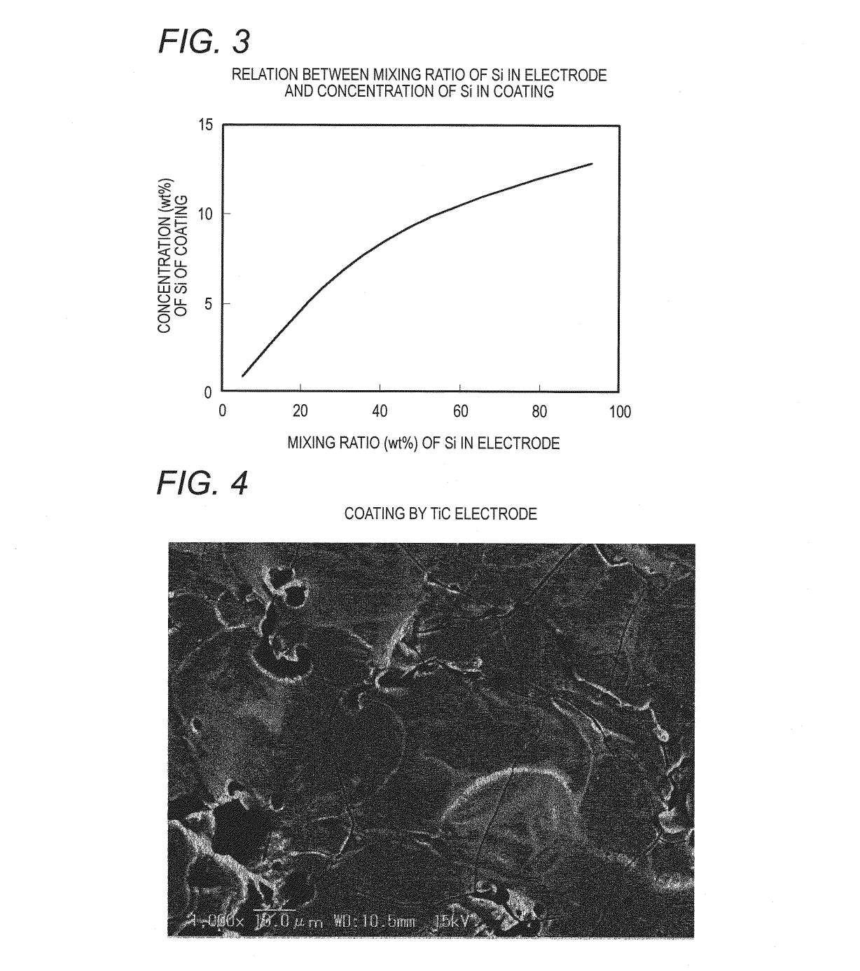

As results of measurement of the Si concentrations of coatings, which are obtained by treating carbon steel S45C by the electrodes of TiC and Si formed while changing the mixed ratio of the Si powder to the TiC powder, a relation between the weight ratio of Si in the electrodes and the Si concentrations of the coatings is as shown in FIG. 3.

As the weight percent of Si in the electrode increases, the Si concentration of the coating also increases.

Here, the amount of Si is a value measured from the surface direction of the coating by an energy dispersive X-ray spectrometry method (EDX), and measurement conditions are an acceleration voltage of 15.0 kV, and an illumination current of 1.0 nA.

As described above, as the mixing ratio of Si in the electrode increases, the concentration of Si contained in the coating increases, and therefore, it can be considered that the surface roughness of the coating is reduced. In order to examine this mechanism, surfaces of the coatings was observed with an SEM. As a result, it was observed that as the concentration of Si increases, defects such as cracks was reduced at the coatings, and a swell of each electric discharge trace was reduced.

Hereinafter, electrodes having different mixing ratios (weight ratios), for example, an electrode in which a mixing ratio of the TiC powder to the Si powder is 8:2 is referred to as a “TiC+Si (8:2) electrode” and an electrode in which a mixing ratio of the TiC powder to the Si powder is 5:5 referred to as a “TiC+Si (5:5) electrode”.

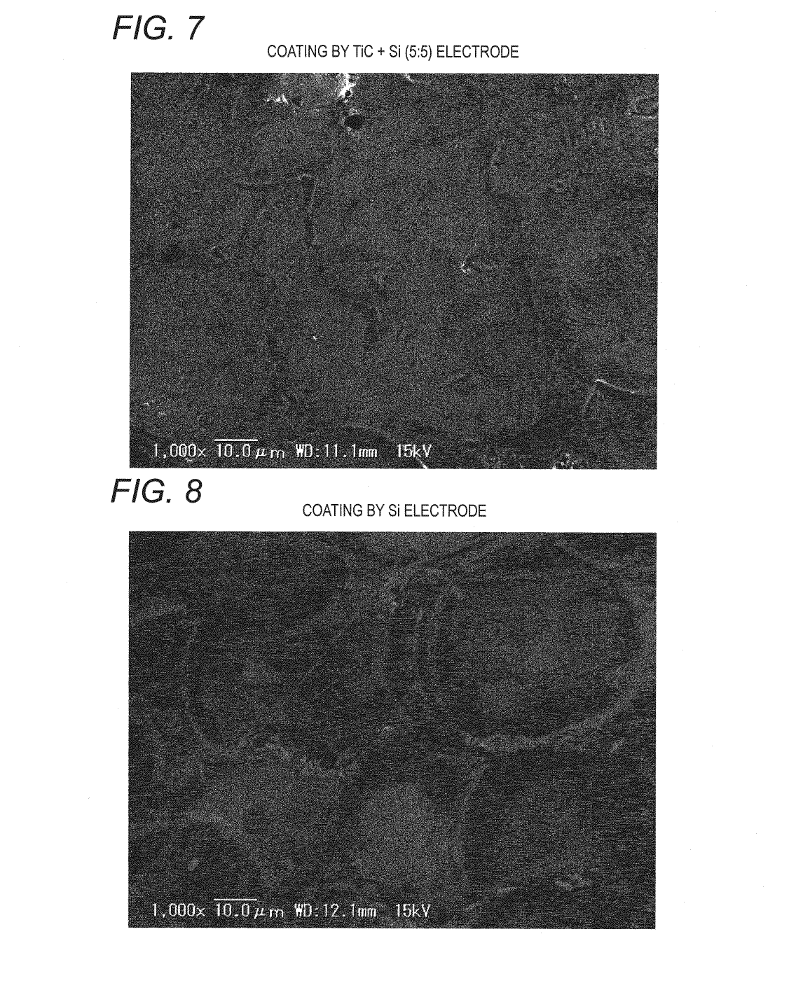

FIGS. 4 to 8 show SEM observation results of a surface treated by a TiC electrode, a surface treated by the TiC+Si (8:2) electrode, a surface treated by a TiC+Si (7:3) electrode, a surface treated by the TiC+Si (5:5) electrode, and a surface treated by an Si electrode.

From the treated surface by the TiC electrode shown in FIG. 4, it can be observed that there are great many defects such as cracks (black lines in FIG. 4) and a swell of each electric discharge trace is large.

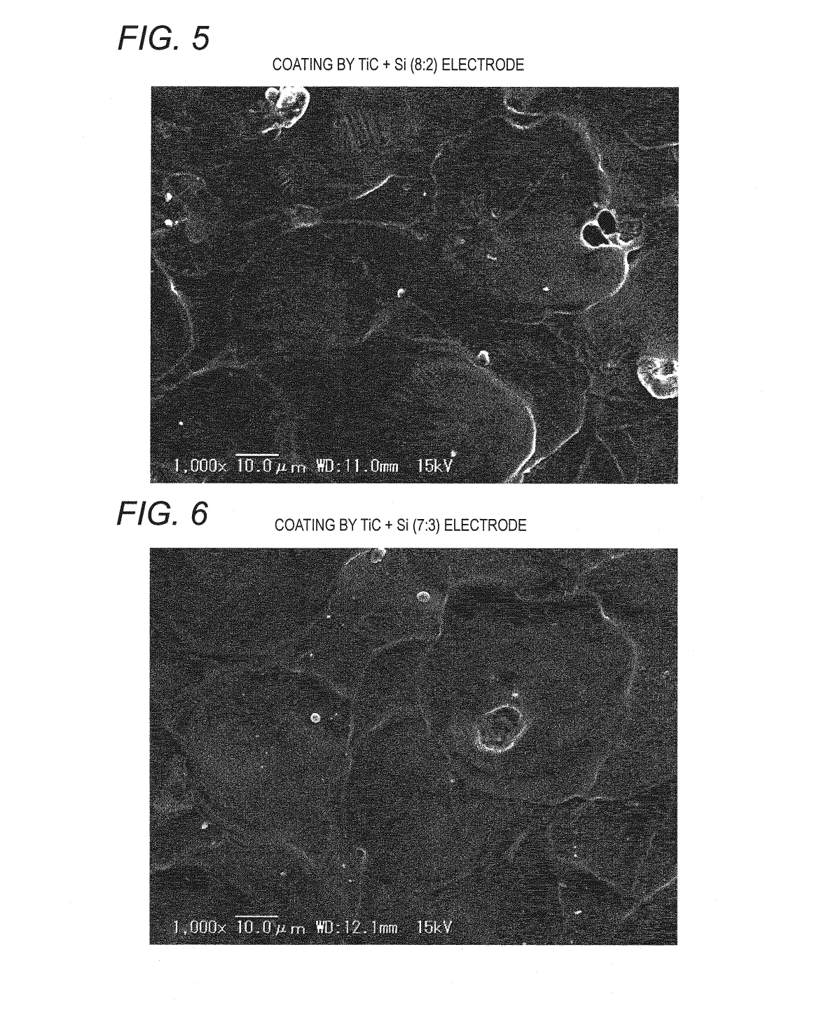

Meanwhile, from FIGS. 5 to 7, it can be observed that defects such as cracks on the treated surfaces decrease and swells of electric discharge traces are reduced in the order of the TiC+Si (8:2) electrode, the TiC+Si (7:3) electrode, and the TiC+Si (5:5) electrode.

Also, from the treated surface by the Si electrode shown for comparison in FIG. 8, it can be observed that any defects such as cracks are not shown and a swell of each electric discharge trace is very small.

Here, a mechanism of the swells of each electric discharge trace reducing due to the concentrations of Si contained in the coatings increasing is considered as follows.

Si has a coefficient of viscosity (0.94 mN·s/m²) smaller than those of other metals. Therefore, if Si is mixed, when an electrode material being melted by electric discharge moves onto a base material and coagulates, since the concentration of Si of the melted portion increases, as a result, the coefficient of viscosity of the melted portion is reduced and the electrode material coagulates while spreading flat. Therefore, it can be considered that swells are reduced.

An X-ray diffraction measurement was performed on the coatings treated by the (TiC+Si) electrodes formed by mixing the TiC powder and the Si powder in different ratios. As a result, a diffraction peak of TiC was confirmed, and it was seen that TiC of the electrode material exists as TiC in the coating even after the electric-discharge surface treatment.

Meanwhile, a diffraction peak of an elementary substance of Ti was not confirmed.

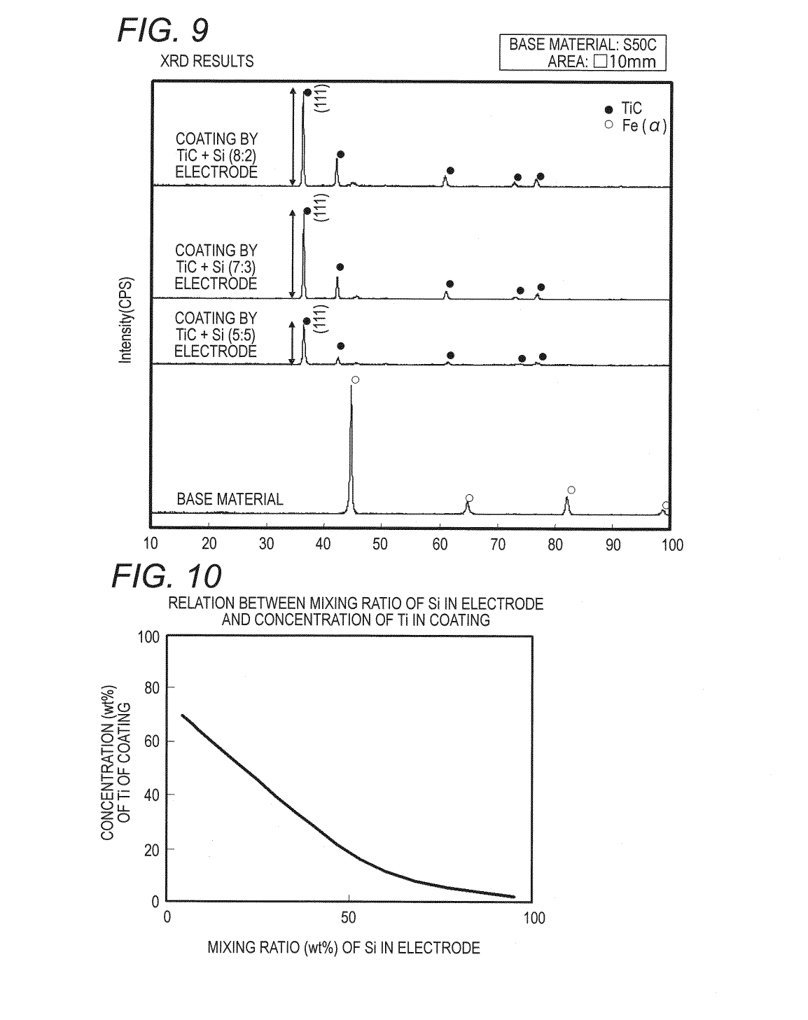

FIG. 9 shows results of XRD diffraction measurement of coatings formed by the TiC+Si (8:2) electrode, the TiC+Si (7:3) electrode, and the TiC+Si (5:5) electrode, as examples.

Meanwhile, as the mixing ratio of Si in the electrode increases, that is, the mixing ratio of TiC in the electrode decreases, integral intensities of all of the diffraction peaks of TiC of the coatings are also reduced.

FIG. 10 shows a relation between the mixing ratio of Si in the electrode and the concentration of Ti in the coating.

As the mixing ratio of Si in the electrode increases, that is, the mixing ratio of TiC in the electrode decreases, the concentration of Ti in the coating is reduced.

Since a peak of the elementary substance of Ti is not shown from the XRD diffraction measurement results, it can be considered that, even though a portion of TiC of an electrode may be decomposed during the electric-discharge surface treatment, most of TiC exists intactly in the coating.

As described above, it can be inferred that if the mixing ratio of Si in the electrode increases, that is, the mixing ratio of TiC in the electrode reduces, the concentration of TiC in the coating also relatively reduces.

As described above, it can be considered that if the mixing ratio of Si in the electrode increases, the concentration of hard TiC in the coating reduces, and thus, the hardness of the coating reduces.

Meanwhile, although the element Si exists at several to several tens wt % at the treated surfaces like in the above-mentioned quantitative analysis, as the results of the X-ray diffraction measurement, it was not possible to confirm the diffraction peaks of crystals of Si at all coatings. Therefore, it can be considered that the elementary substance Si forms an alloy together with the components of the base material, or is in an amorphous state.

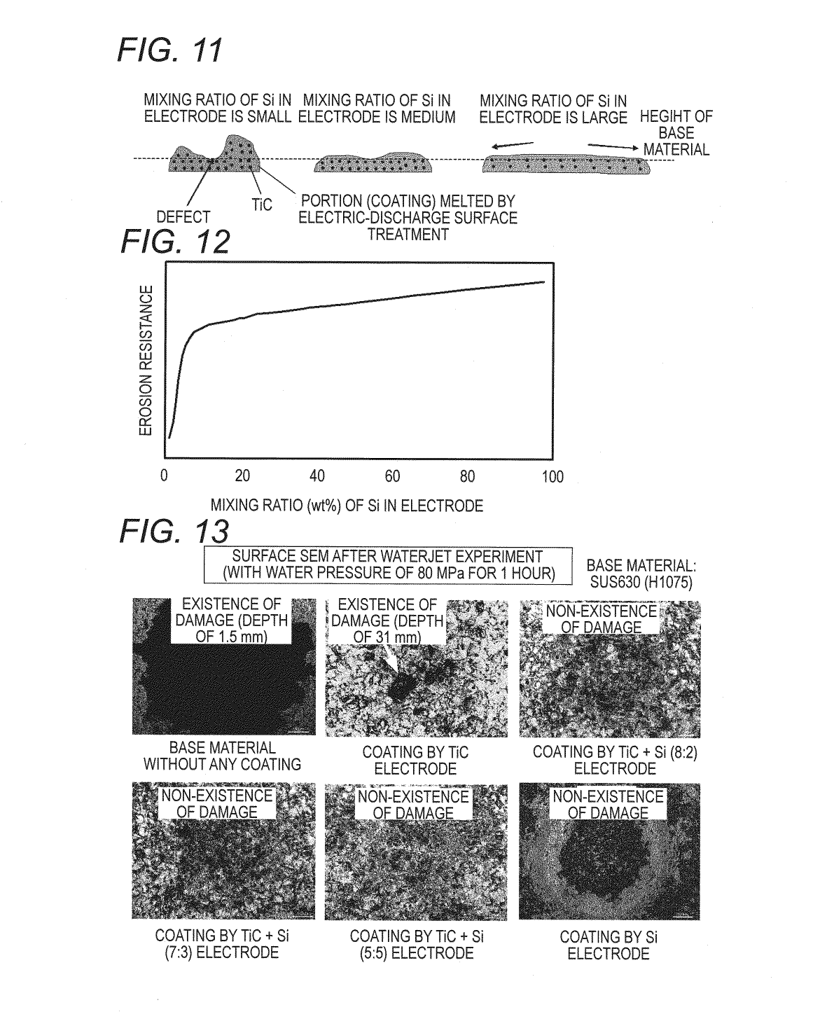

Effects obtained by mixing Si in the electrode and increasing the concentration of Si in the coating are summarized as shown in FIG. 11.

When the mixing ratio of Si in the electrode is small, at the portion (the coating) having melted by the electric-discharge surface treatment, there are many defects such as cracks and a swell of each electric discharge trace is large.

Meanwhile, as the mixing ratio of Si increases, defects such as cracks are reduced, and a swell of each electric discharge trace is reduced. Also, regarding the coating, it can be inferred that the elementary substance of Si and the components of the base material form an alloy or are in an amorphous state, and it is inferred that TiC spreads therein.

A portion of the coating spreads to a position lower than the height of the base material.

The coating including the spread portion is about 5 μm to 20 μm.

Next, the erosion resistance of each of the coatings treated by the TiC+Si electrodes formed by mixing the TiC powder and the Si powder at slightly different ratios is evaluated.

In the evaluation, the base material is SUS630 (H1075).

The erosion resistance is evaluated by hitting the coatings with waterjet.

It is generally said that the erosion resistance has a strong correlation with the hardness. Meanwhile, it has been known that the erosion resistance has many points which cannot be explained only by the hardness, and is influenced by the characteristics of surfaces as a factor other than the hardness, and the erosion resistance of a smooth surface is higher than that of a rough surface.

Although it has been known that high erosion resistance is obtained at the coating treated by the Si electrode, as results of this evaluation, an improvement in the erosion resistance began to appear at the coatings treated by the electrodes formed by mixing 5 wt % or more of Si in TiC.

When Si was contained at about 5 wt %, some defects existed at the surface, and thus a variation was seen in the evaluation. Therefore, it was found out that if the mixing ratio of Si is further increased, it is possible to give a sufficient effect when the mixing ratio of Si is 10 wt % or greater, and it is more preferable to mix Si at 20 wt % or greater.

FIG. 12 is a view illustrating a relation between the mixing ratio of Si in the electrode and the erosion resistance. FIG. 12 shows that, in a case of mixing Si at 20 wt % or greater, the coating has high erosion resistance without a variation in the evaluation.

It is thought that the coating has high erosion resistance as described above due to combined effects of the following points.
Since the coating is amorphous, it is difficult for breaking to occur from particle boundaries.
Since TiC spreads, the hardness is high.
Since Si is mixed, the coating is smooth.

FIG. 13 shows results of observation of the surface states of the coatings treated by the TiC+Si (8:2) electrode, the TiC+Si (7:3) electrode and the TiC+Si (5:5) electrode after injection of waterjet of 80 MPa for one hour, as examples. FIG. 13 also shows results of observation of only the base material, the coating by the TiC electrode, and the coating by the Si electrode for comparison. At the base material without any coating, damage had occurred, and even at the treated surface by the TiC electrode, damage had occurred.

Meanwhile, at all of the coatings treated by the TiC+Si (8:2) electrode, the TiC+Si (7:3) electrode, and the TiC+Si (5:5) electrode, damage had not occurred.

Next, the corrosion resistance of each of the coatings was evaluated. In this evaluation, the base material was SUS 316.

Although it is known that high corrosion resistance is obtained at the coating treated by the Si electrode, the coatings treated by the electrodes formed by mixing Si at 5 wt % or greater in TiC has high corrosion resistance.

When Si was contained at about 5 wt %, a few defects existed at the surface, and thus a variation in the evaluation was seen. Therefore, if the mixing ratio of Si further increases, it is possible to give a sufficient effect when the mixing ratio of Si is 10 wt % or greater, and it is more preferable to mix Si at 20 wt % or greater.

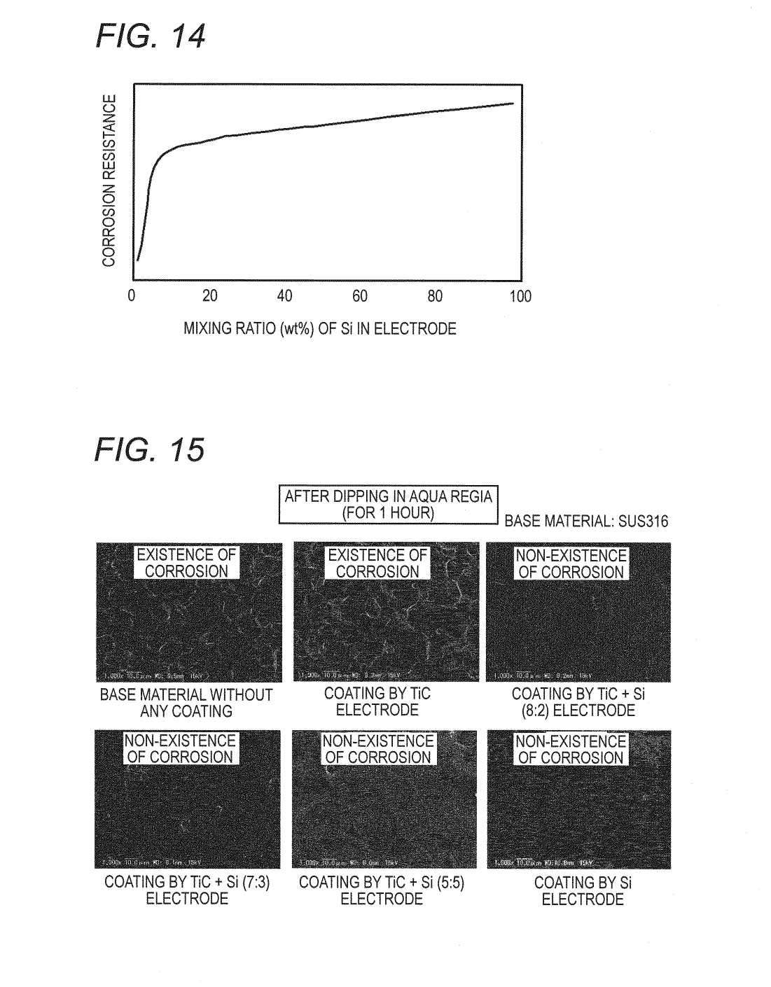

When the mixing ratio of Si was 20 wt % or greater, high corrosion resistance was obtained without a variation in the evaluation. FIG. 14 schematically shows a relation between the mixing ratio of Si in the electrode and the corrosion resistance.

It is thought that the coating has high corrosion resistance as described above due to combined effects of the following points.
Since the coating is amorphous, it is difficult for breaking to occur from particle boundaries.
Since Si is mixed, defects such as cracks are few.

FIG. 15 shows results of observation of the surface states of the coatings treated by the TiC+Si (8:2) electrode, the TiC+Si (7:3) electrode, and the TiC+Si (5:5) electrode after dipping in aqua regia serving as a corrosion solution for one hour, as examples.

FIG. 15 also shows results of observation of the base material without any coating, the coating by the TiC electrode, and the coating by the Si electrode for comparison.

The base material without any coatings greatly corroded, and the surface treated by the TiC electrode also corroded.

Meanwhile, at all of the coatings treated by the TiC+Si (8:2) electrode, the TiC+Si (7:3) electrode, and the TiC+Si (5:5) electrode, corrosion had not occurred.

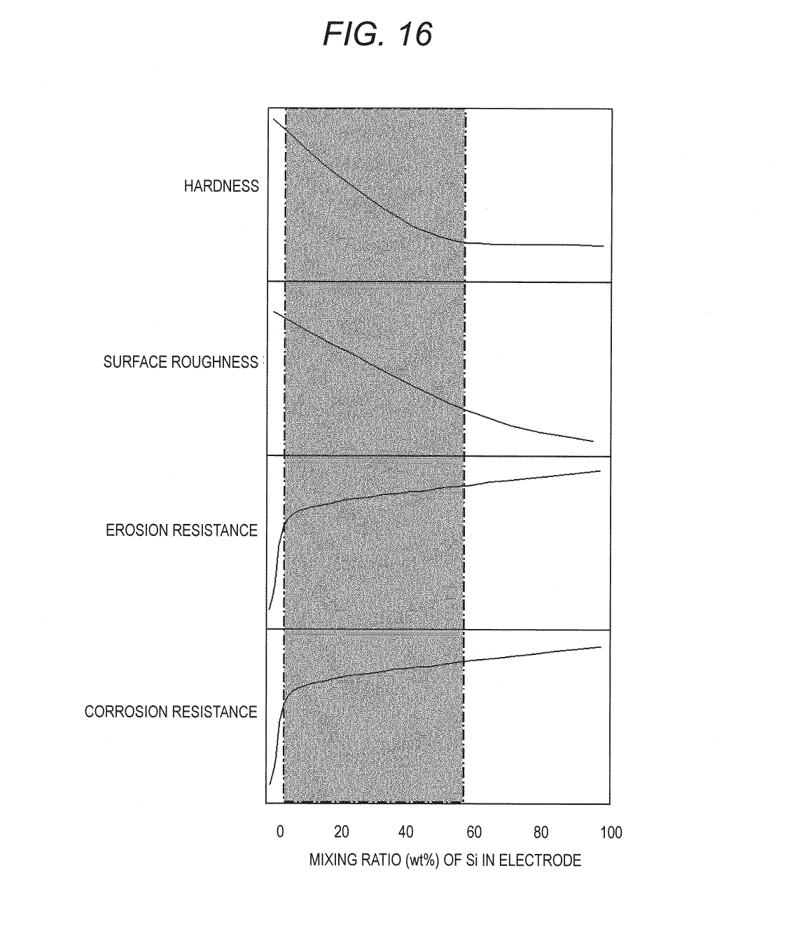

From the results obtained until now, if the mixing ratio (weight ratio) of Si in the electrode for electric-discharge surface treatment is taken on a horizontal axis, and the characteristics (the surface roughness, the hardness, the erosion resistance, and the corrosion resistance) of the coating obtained by treatment by the electrode are taken on a vertical axis, graphs as shown in FIG. 16 are obtained.

That is, when the mixing ratio of Si is 50 wt % to 60 wt %, it is possible to form a smooth coating having high hardness, high erosion resistance, and high corrosion resistance.

When the mixing ratio of Si is 5 wt % or less, the surface roughness is at the same degree as that of the coating by the TiC electrode, and sufficient erosion resistance and corrosion resistance are not obtained. Also, when the mixing ratio of Si is 60 wt % or greater, the hardness is at the same degree as that of the coating by the Si electrode is obtained, and the other characteristics also are at the same degrees as those of the coating by the Si electrode. Particularly, the surface roughness is deteriorated.

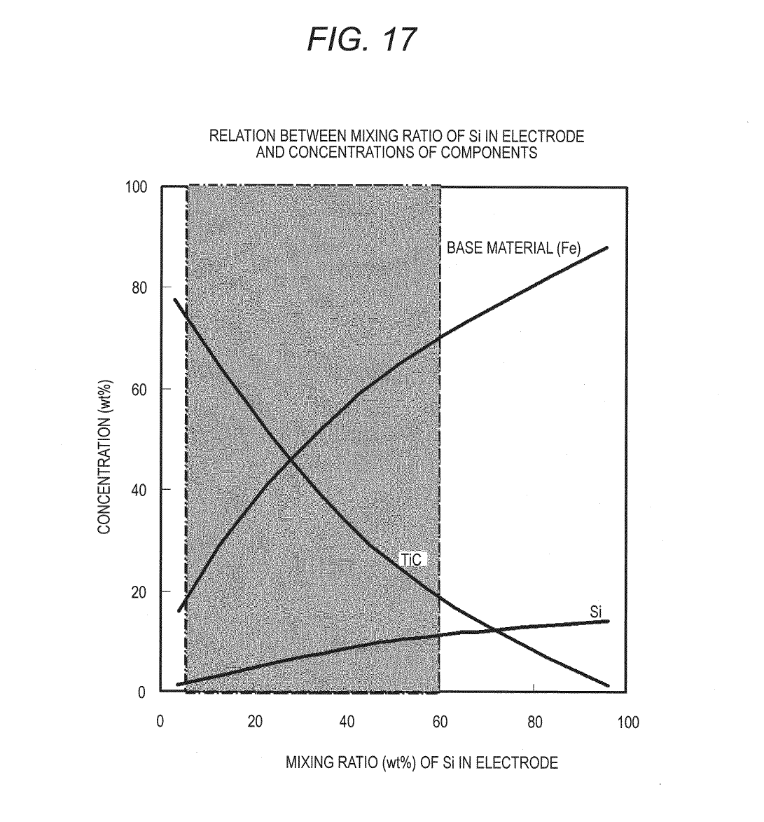

From results of element concentration measurement and X-ray diffraction by the EDX, the concentrations of Si, TiC, and a base material (Fe) of a coating, which is obtained by treating carbon steel S45C by TiC+Si electrodes formed by mixing the Si powder at slightly different ratios in the TiC powder, are as shown in FIG. 17.

As described above, the concentrations of Si, TiC, and the base material component (Fe) of a smooth coating with high hardness, high erosion resistance, and high corrosion resistance formed on carbon steel S45C by electrodes containing Si at the mixing ratio of 50 wt % to 60 wt % were in ranges of 1 wt % to 11 wt %, 10 wt % to 75 wt %, and 20 wt % to 90 wt %, respectively.

In the present embodiment, the case of mixing Si in TiC has been described. However, since good characteristics are obtained due to the above-mentioned reasons, instead of TiC, other hard materials, for example, metals such as W and Mo, and ceramics such as carbides including WC, VC, Cr₃C₂, MoC, SiC, and TaC may also be used. Also, nitrides such as TiN and SiN and oxides such as Al₂O₃ may also be used.

In a case of using an insulator, by sufficiently mixing Si so as to ensure electrical conductivity, it is possible to obtain the same effects.

In a case where another material and Si was mixed within the same volume ratio range as that in the case of TiC and Si, the same effects were obtained. In the present embodiment, the mixing ratio of TiC to Si has been defined. However, since the density of TiC is 4.93 g/cm³ and the density of Si is 2.3 g/cm³, if the volume ratio is calculated by dividing weights by the densities, for example, when the weight ratio of TiC to Si is 95(wt %):5(wt %), the volume ratio of TiC to Si is 90 vol % (volume percent):10 vol %, and when the weight ratio of TiC to Si is 40(wt %):60(wt %), the volume ratio of TiC to Si is 25 vol %:75 vol %.

In other words, if Si is mixed at 10 vol % to 75 vol % in another hard material, it is possible to form a sooth coating having high hardness, high erosion resistance, and high corrosion resistance.

Also, in the present embodiment, Si has been used as a material to be mixed. However, even when metal powder having a small coefficient of viscosity is mixed, it is possible to obtain the same effects. Instead of Si, a material having a small coefficient of viscosity, such as K, Li, Na, Ge, Ca, Mg, Al, P, Bi, Sn, or In, may also be used.

In the present embodiment, the TiC powder and the Si powder are mixed at a predetermined weight ratio. However, a powder containing TiC and Si at a predetermined ratio in advance may be used to form an electrode for electric-discharge surface treatment. This case is more preferable since it is possible to uniformly mix TiC and Si.

In the present embodiment, the Fe-base material is used as the base material. However, even if other materials are used, it is possible to obtain the same effects.

For example, even if the base material is a Ni-base alloy or a Co-base alloy of heat-resistant alloys, it is possible to obtain the same effects.

Also, in a case where the base material is Al-based or Cu-based, the coating by the TiC electrode has surface roughness higher than that in the case where the base material is Fe-based. However, if a TiC+Si electrode is used, it is possible to obtain the same effects.

As an invention in which Si is added to an electrode material, there is JP-A-556-51543. However, this is an invention regarding an electrode for general electric discharge machining, is for increasing a machining speed, and is an invention in a field different from the present invention in which a hard material coating is formed, and Si is mixed such that the coating becomes smooth, whereby a coefficient of viscosity is reduced.

JP-A-2005-21355 is for establishing a surface treatment method for a dense and relatively thick coating (made of a metal material in the order of 100 μm or greater) with no vacancy which needs a strength and lubricity in a high temperature environment, and discloses an electrode for electric-discharge surface treatment containing 1.0 wt % to 4.5 wt % of B (boron) or 1.5 wt % to 5.0 wt % of Si (silicon) as an electrode material for absorbing oxygen atoms.

However, the present invention is for establishing a surface treatment method of a smooth and high-hardness coating of a hard material having a thickness 5 μm to 20 μm, and uses a weight ratio of mixed Si of 5 wt % to 60 wt %. Therefore, the present invention is an invention in a field different from JP-A-2005-21355.

### INDUSTRIAL APPLICABILITY

The electrode for electric-discharge surface treatment according to the present invention can be appropriately used for electric-discharge surface treatment work on metal molds, steam turbines, and the like.

1. An electrode for electric-discharge surface treatment, which is used in an electric-discharge surface treatment in which pulsed electric discharge is generated between the electrode and a base material in a machining fluid or in the air by using a green compact, which is formed by compressing powder of an electrode material, as the electrode, and by using energy of the electric discharge, a coating including the electrode material or a reaction product of the electrode material reacted by the electric discharge energy is formed on a surface of the base material,
wherein, as the powder of the electrode material, a mixed powder formed by mixing 10 to 75 vol % of Si powder to powder of a hard material is used.

2. The electrode for electric-discharge surface treatment according to claim 1,
wherein, as the powder of the hard material, TiC, a metal such as W or Mo, a ceramic such as WC, Cr₃C₂, MoC, SiC or TaC, a nitride such as TiN or SiN, or an oxide such as Al₂O₃ is used.

3. An electrode for electric-discharge surface treatment, which is used in an electric-discharge surface treatment in which pulsed electric discharge is generated between the electrode and a base material in a machining fluid or in the air by using a green compact, which is formed by compressing powder of an electrode material, as the electrode, and by using energy of the electric discharge, a coating including the electrode material or a reaction product of the electrode material reacted by the electric discharge energy is formed on a surface of the base material,
wherein, as the powder of the electrode material, powder containing a hard material component and 10 to 75 vol % of an Si component is used.

4. The electrode for electric-discharge surface treatment according to claim 3,
wherein, as the powder of the hard material, TiC, a metal such as W or Mo, a ceramic such as WC, Cr₃C₂, MoC, SiC or TaC, a nitride such as TiN or SiN, or an oxide such as Al₂O₃ is used.

5. The electrode for electric-discharge surface treatment according to claim 1,
wherein the Si powder or the Si component is substituted with any one of K, Li, Na, Ge, Ca, Mg, Al, P, Bi, Sn, In, which are metals having small coefficients of viscosity.

6. An electric-discharge surface treatment coating which includes an electrode material or a reaction product of the electrode material reacted by energy of pulsed electric discharge and is formed on a surface of a base material, the coating being formed by using the pulsed electric discharge generated between an electrode and the base material in a machining fluid or in the air by using a green compact, which is formed by compressing powder of the electric material, as the electrode,
wherein the electric-discharge surface treatment coating includes 1 to 11 wt % of Si and 10 to 75 wt % of TiC spread therein, when the base material is Fe-based.

7. The electrode for electric-discharge surface treatment according to claim 3,
wherein the Si powder or the Si component is substituted with any one of K, Li, Na, Ge, Ca, Mg, Al, P, Bi, Sn, In, which are metals having small coefficients of viscosity.
